(19) United States
(12) Patent Application Publication
(10) Pub. No.: US 2014/0134555 A1
(43) Pub. Date: May 15, 2014

(54) THERMAL ISOLATION WALLS IN A ROTARY FURNACE APPLICATION

(71) Applicant: FIRTH RIXSON, East Hartford, CT (US)

(72) Inventors: David Hebert, Shrewsbury, MA (US); Matthew J. Villani, Spring, TX (US)

(73) Assignee: FIRTH RIXSON, East Hartford, CT (US)

(21) Appl. No.: 13/676,552

(22) Filed: Nov. 14, 2012

(51) Int. Cl. F27D 11/02; F27D 11/06; F27D 3/12; F27D 7/06; F27D 1/00; F27B 19/00

(52) U.S. Cl. CPC F27D 11/02; F27D 1/0036; F27B 19/00; F27D 3/12; F27D 7/06; F27D 11/06
USPC 432/11; 219/389; 432/238; 432/247; 432/23

(57) ABSTRACT

Rotary furnaces and processes for heat treating a workpiece generally include an external shell wall and a refractory lining abutting the shell wall to define a substantially cylindrically shaped interior chamber for treating one or more workpieces; an opening in the an external shell wall and a refractory lining for loading and unloading the workpieces; a rotatable hearth for receiving and rotating the workpieces within the substantially cylindrically shaped interior chamber; and a plurality of thermal isolation walls, wherein adjacent thermal isolation walls define a space effective to accommodate and thermally shield each one of the workpieces to be treated and have a height at least equal to a height of the workpiece. The presence of the thermal isolation walls substantially prevents heat transfer between the workpieces being treated.

### BACKGROUND

The present disclosure generally relates to rotary furnaces, and more particularly, to rotary furnaces having multiple heating zones for treatment of a workpiece under conditions of high temperature and, in some instances, under high vacuum.

A rotary furnace, also sometimes referred to as a rotary kiln, is a type of pyroprocessing device generally configured to heat materials, typically workpieces such as metal billets, to very high temperatures and oftentimes, under high vacuum to carry out processes such as forging, brazing, sintering, calcination, heat treatment, and the like with high consistency and low contamination. The absence of air or other gases prevents heat transfer with the product through convection and advantageously removes a source of oxidation of furnace components and/or workpieces and reduces contamination to workpieces. Typically, the rotary furnace includes a single chamber that is resistively or inductively heated. Workpieces to be treated within the rotary furnace are typically loaded and unloaded onto a rotating hearth within a single chamber.

The basic components of a rotary furnace generally include a shell, a refractory lining or insulation, a rotating hearth, one or more vacuum pumps, drive gears, internal heat exchangers, and the like. The shell is typically made from a rolled mild steel plate. The refractory lining insulates the steel shell from the high temperature inside the furnace, and protects it from the corrosive properties of the material being processed. It may consist of refractory bricks or cast refractory concrete, graphite insulation sheets, or may be absent in zones of the furnace that are below about 250° C. when the furnace is in use. The particular refractory material for the bricks or concrete generally depends upon the temperature inside the kiln and the chemical nature of the material that is to be processed within the furnace. In some processes, the refractory life is prolonged by maintaining a coating of the processed material on the refractory surface. A typical refractory material will be capable of maintaining a temperature drop of 1000° C. or more between its hot and cold faces.

One of the problems with current rotary furnaces is that they typically rely on a load/unload method, wherein workpieces are sequentially loaded and unloaded in a single chamber. As new workpieces are loaded, heat is leeched away from the warmer workpieces to the colder ones increasing the former's total soak time or more importantly affecting the former's temperature uniformity. As the heat loss from the former workpiece is not uniformly distributed, non-uniform heating can deleteriously occur and impact the desired crystal structure in the workpiece to be treated. For example, rotary vacuum furnaces are often employed for isothermal forging in which a constant and uniform temperature is maintained in the workpiece during forging. Minute variations in temperature, along with the amount of time spent at certain temperature levels (i.e., soak times), can significantly affect material properties such as surface grain structure for the workpiece being treated. For critical parts such as those used in the aerospace industry, a premium is typically placed on the ability to control these variables as much as possible.

### BRIEF SUMMARY

Disclosed herein are rotary furnaces for treatment of a workpiece under conditions of high temperature and processes of use.

In one embodiment, a rotary furnace for treatment of a workpiece under conditions of high temperature comprises an external shell wall and a refractory lining abutting the shell wall to define a substantially cylindrically shaped interior chamber for treating one or more workpieces; an opening in the external shell wall and the refractory lining for loading and unloading the workpieces; a rotatable hearth for receiving and rotating the workpieces within the substantially cylindrically shaped interior chamber; and a plurality of thermal isolation walls, wherein adjacent thermal isolation walls define a space effective to accommodate and thermally shield each one of the workpieces to be treated and have a height at least equal to a height of the workpiece.

A process for heating multiple workpieces in a rotary furnace comprises introducing a first workpiece onto a rotating hearth of the rotary furnace, wherein the rotating hearth comprises a plurality of thermal isolation walls spaced apart from one another, wherein adjacent thermal isolation walls define a space effective to accommodate and thermally shield the first workpiece and have a height at least equal to a height of the first workpiece, and wherein the first workpiece is contained between the adjacent thermal isolation walls; introducing an additional workpiece onto the rotating hearth, wherein the additional workpiece is disposed between adjacent thermal isolation walls, wherein at least one of the adjacent thermal isolation walls containing the additional workpiece is different than the adjacent thermal isolation walls containing the first workpiece, wherein heat transfer between the first workpiece and the additional workpiece and/or an adjacent heating zone is substantially prevented; and heat treating the first and additional workpieces.

Other aspects, features and advantages of the disclosure will be more fully apparent from the ensuing disclosure and appended claims.

### BRIEF DESCRIPTION OF THE DRAWINGS OF THE SEVERAL VIEWS OF THE DRAWINGS

Referring now to the figures wherein the like elements are numbered alike:

FIG. 1 illustrates a top plan view of rotary furnace in accordance with an embodiment of the present disclosure.

FIG. 2 illustrates a partial perspective view of a rotary furnace in accordance with an embodiment of the present disclosure.

FIGS. 3 and 4 illustrate the results of a SolidWorks Computational Fluid Dynamics simulation showing a hot billet (2000° F.) placed next to a cold billet (72° F.) in two different positions. One at the rear of the furnace and one loaded next to the door.

### DETAILED DESCRIPTION

Disclosed herein are rotary furnaces including multiple treatment zones, wherein each zone is defined by thermal isolation walls as will be described in greater detail herein so as to minimize heat transfer effects and provide more uniform heating of workpieces. Advantageously, the thermal isolation walls mitigate both undesirable heat transfer between workpieces placed inside the furnace and interaction between adjacent heating elements that may be configured to operate at dissimilar processing temperatures. Additionally, the presence of the thermal isolation walls provide for a faster and more repeatable pass-through rate for heated workpieces as each zone is insulated form thermal losses associated with loading and unloading of workpieces to and from the furnace. Consequently, the rotary furnace can be run in a batch mode or in a continuous mode, thereby conserving valuable operating time that would otherwise have been lost to reload the furnace during the batch mode operation in prior rotary furnace configurations. As is generally understood by those in the art, batch mode operation generally refers to a method of furnace operation in which all workpieces are loaded at the same time so as to simultaneous reach the desired processing temperature under the same conditions. In contrast, continuous mode operation generally refers to a method of furnace operation in which all workpieces are heated individually in consecutive order, thereby allowing the furnace to be backloaded with additional workpieces while simultaneous treating workpieces that had previously been loaded into the furnace. Because of the above features, the rotary furnace of the present disclosure is well suited for isothermal forging

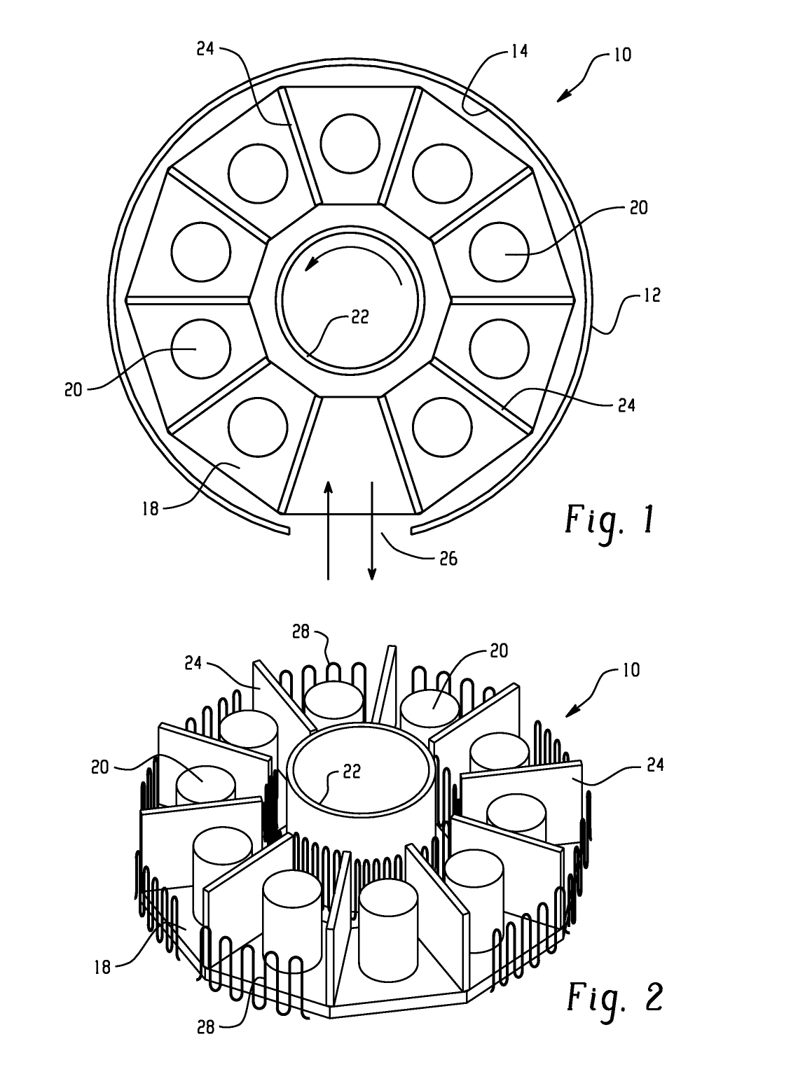

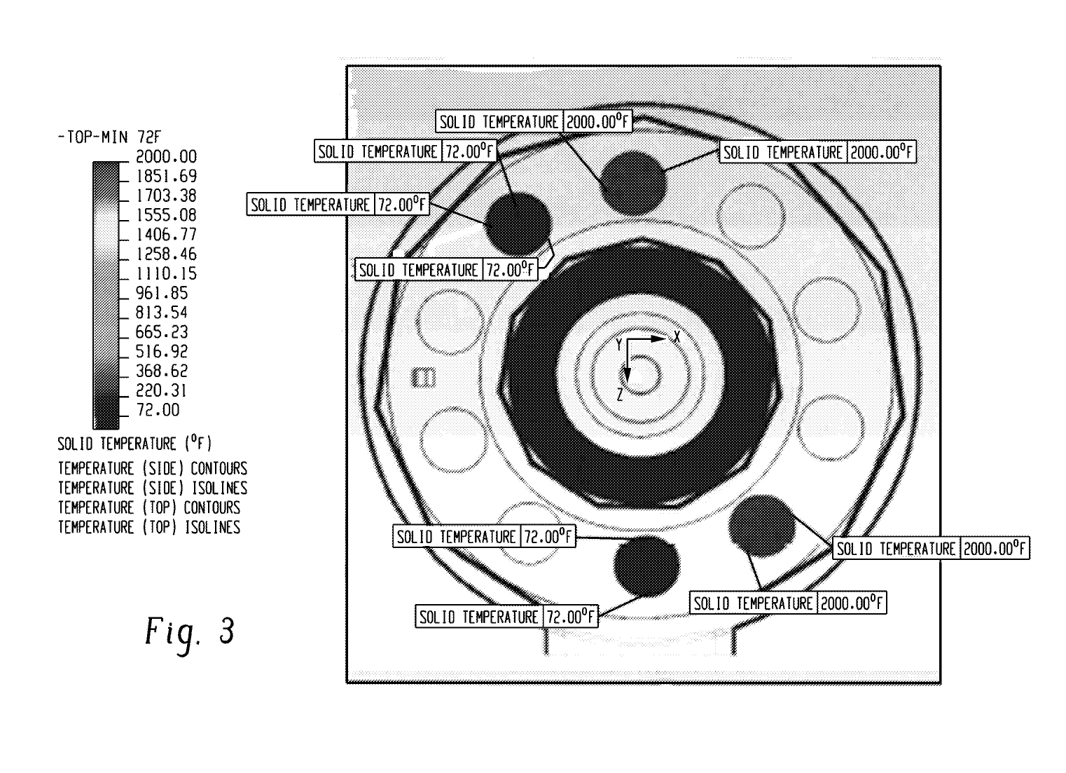

Turning now to FIGS. 1 and 2, there is depicted an exemplary rotary furnace generally designated by reference numeral 10 in accordance with the present disclosure. It should be understood that the illustrated rotary furnace has been simplified to illustrate only those components that are relevant to understanding of the present disclosure. Those of ordinary skill in the art will recognize that there are other components that may be included to produce an operational rotary furnace. However, because such components are well known in the art, and because they do not aid in further understanding of the present disclosure, a discussion of such components is not provided.

The rotary furnace 10 includes an external shell wall 12 and a refractory lining 14 abutting the shell wall 12 to define a substantially cylindrically shaped interior chamber for treating one or more workpieces 20. A rotatable hearth 18 is disposed within the substantially cylindrically shaped chamber and configured to receive and rotate the workpiece 20 about an axis. The rotary furnace 10 further includes an inner annular wall 22 separate from the rotatable stage such that the inner annular wall remains stationary upon rotation of the rotatable hearth. The inner annular wall can be formed of an insulated or heat reflective material. Thermal isolation walls 24 are spaced apart from one another to define various zones within the chamber, wherein each zone can house a workpiece 18 to be treated. At least one opening 26 is provided in the furnace for loading and unloading workpieces. A door (not shown) covers the opening. As shown more clearly in FIG. 2, the furnace further includes one or more heating elements 28 (e.g., resistive or inductive) circumferentially disposed about cylindrically shaped inner annular wall 22 and the exterior refractory lining 14. The various heating elements can be configured to provide the same or different heating profiles and temperatures within each zone.

Each of the thermal isolation walls 24 generally extends from the inner annular wall 22 to about the refractory lining 14 and is formed of an insulative material. The vertical height of the walls is at least equal to or greater than a height of the workpiece 20 disposed therein. That is, line of sight of the workpiece from the opening and between adjacent workpieces is substantially prevented. The spacing between adjacent walls is at least equal to a width of the workpiece being treated. By employing the thermal isolation walls between workpieces being processed in the rotary furnace, confounding variables are largely negated during controlled heating allowing for much more repeatable and predictable processing techniques than past applications.

The refractory lining 14 in the walls and the rotating hearth as well as the thermal isolation walls 24 can be formed of any refractory materials suitable for use at the intended temperatures. Suitable refractory materials are chemically and physically stable to the processed materials and at the intended high temperatures employed within the furnace. Exemplary refractory materials are produced from natural and synthetic materials, usually nonmetallic, or combinations of compounds and minerals such as alumina, fireclays, bauxite, calcium, chromite, dolomite, graphite, magnesite, silicon carbide, zirconia, graphite, tantalum, molydenum, and the like. In one embodiment, the thermal isolation walls are formed of graphite, which provides a relatively low thermal mass compared to other insulative materials.

In some embodiments, the rotary furnace is configured to operate at a vacuum in a range of about 10 to 100 microns. Molybdenum and graphite are often used for the vacuum-furnace insulation. By way of example, in a standard vacuum furnace with a maximum 1315° C. (2400° F.) operating temperature, the heat shielding often consists of two layers of molybdenum sheet backed by three layers of stainless steel sheet. For higher operating temperatures, the number of molybdenum layers can be increased as well as the thickness of each layer. For very high operating temperatures over 1650° C. (3000° F.), tantalum sheet can be used in place of molybdenum. The insulating properties of the all-metal design come mostly from the gaps between the layers of sheet metal. These gaps prevent heat from being conducted outward from the hot zone. The reflectivity of the inner molybdenum sheet also helps to direct the radiant heat from the elements inward toward the load. All-metal hot zones tend to be preferred when high-vacuum or very clean processing environments are required. Care must be taken in operating furnaces with all-metal hot zones because some metal such as molybdenum embrittles due to recrystallization after a single exposure to temperatures above about 1150° C. (2100° F.). Embrittled heat shields can be relatively easily damaged if struck by fixtures or parts. Moreover, due to the high cost of molybdenum, all-metal hot zones also tend to be more expensive than some other choices.

The rotating hearth 18 is the structure that supports the load, i.e, workpiece, during heat treating. Again, molybdenum and graphite are the most popular choices as hearth materials in vacuum furnaces. The hearth is usually constructed of rails upon which the load sits, with the rails supported by pins mounted on reinforced areas of the furnace chamber. Because of the material's higher strength, a molybdenum hearth can be built with less material than a graphite hearth designed to support the same load. Unlike the molybdenum sheet used in elements and heat shields, the thicker sections of molybdenum used in the hearth components are not easily damaged even after recrystallization. Molybdenum hearth rails sometimes warp after long-term thermal cycling, however, and must occasionally be hot straightened. A graphite hearth is very rigid and will maintain its shape almost indefinitely. Though its heavier mass may result in slower heating rates at lower temperatures, the good thermal conductivity of graphite tends to minimize this effect. While usually less expensive than molybdenum, graphite hearth rails can be prone to chipping during transfer of furnace loads. Newly developed graphite-fiber-based materials are more resistant to chipping but very expensive even compared to molybdenum.

With a rotary furnace such as that disclosed in the Figures, the majority of heat transfer is derived from the effects of radiation. Because of this, simplistic modeling can be used to illustrate heat transfer effects of a rotary furnace with and without the thermal isolation walls as described herein. In a worst case scenario, a billet is put through a complete furnace cycle, nearly reaching thermal equilibrium at, for example, approximately about 1900° F., (1200 K). The billet is rotated through the furnace and is waiting for unload at a position just prior to the load/unload position. A room temperature billet, at approximately 75° F. (300 K) is added to the load position, which is adjacent to the billet at near thermal equilibrium. The billet at near thermal equilibrium will need to stay in place for some duration until it is ready for unload. As a further simplification, consider the furnace walls to be a uniform environment at 2000° F. The power to the resistive or inductive coils can be adjusted to achieve roughly this end.

Treating both billets as very long cylinders, the instantaneous heat transfer (q) from the billet at near thermal equilibrium to the room temperature billet and subsequent temperature rise would be governed by the following formulas:

q₁₋₂=σ·A₁·F₁₋₂(T₁⁴−T₂⁴)*e (I)

Δq=ΔT·m·cₚ (II)

wherein, σ is the Stefan Boltzman constant, A is the surface area, F is the view factor, e is the surface emissivity, m is the mass, cₚ is the specific heat, and T is temperature.

Using a cylindrical billet having a diameter 0.3 meters, a height of 0.6 meters, and mass of 300 kilograms as an example, the initial heat transfer described above would be approximately 0.123 K/s. As the temperatures approach one another, the rate of heat transfer will decrease. Moreover, the effect of cooling will be most pronounced on the face of the billet closest to the room temperature billet.

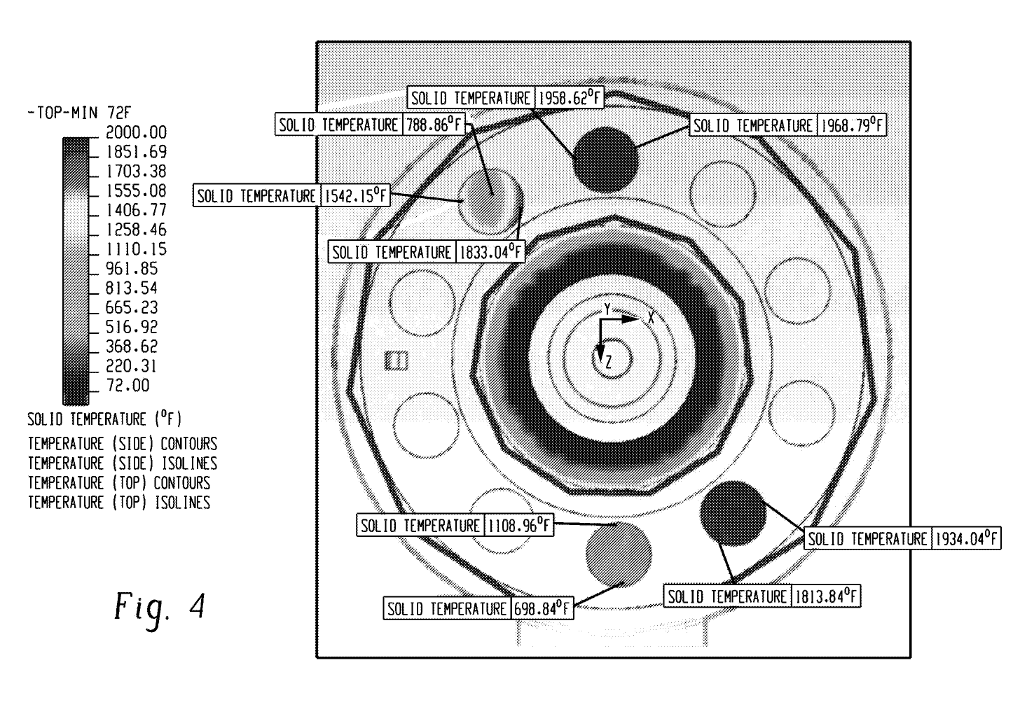

FIGS. 3 and 4 provide simulation data using SolidWorks Computational Fluid Dynamics showing a hot billet at 2000° F. placed next to a relatively cold billet at 72° F. in two different positions, e.g., at the rear of the furnace and loaded next to the door of the furnace. After one hour of run time, the overall temperature of the hot billet at operating temperature in the rear-most position has dropped substantially with a noticeable thermal gradient, while the average temperature of the hot billet at operating temperature placed near the door has dropped nearly two times that of the billet in the rear-most position with an even larger thermal gradient These differences can cause significant structural asymmetry within each billet, resulting in crystalline inhomogeneities.

However, by employing thermal isolation walls throughout the furnace, as shown in FIG. 2, confounding variables in controlled heat-up are negated. Power applied to the heating elements can be monitored and adjusted independently for each position as needed. This largely negates detrimental thermal fluctuations during the heat-up process. The presence of the thermal isolation walls enables a tighter tolerance for overall temperature and higher levels of uniformity throughout each position.

Advantageously, the rotary furnace as described herein provides improved control and precision in the heating of materials in a rotary furnace through the addition of thermally insulating walls. Insulating walls are employed to separate the furnace heating area into individual zones. This allows for detailed monitoring and adjustment of the heat-up conditions for a workpiece, typically a metal billet. These walls help mitigate both undesirable heat transfer between components placed inside the furnace and interactions between adjacent heating elements operating at dissimilar process temperatures. Additionally, the isolation walls allow for a faster, more repeatable pass-through rate for heated billets as each zone is insulated from thermal losses associated with the load/unload procedure of parts. The furnace method of operation now can be run in either a batch manner or a continuous manner, conserving valuable press operating time that would otherwise have been lost for isothermal forging.

Moreover, employing thermal isolation walls negates the confounding variables in controlled heat-up as previously noted. Temperature can be monitored and adjusted independently for each zone, largely negating detrimental thermal fluctuation during heat-up. Thermal isolation walls enable a tighter tolerance for overall temperature and higher levels of uniformity throughout each part.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A rotary furnace for treatment of a workpiece under conditions of high temperature, the rotary vacuum furnace comprising:
an external shell wall and a refractory lining abutting the shell wall to define a substantially cylindrically shaped interior chamber for treating one or more workpieces;
an opening in the external shell wall and the refractory lining for loading and unloading the workpieces;
a rotatable hearth for receiving and rotating the workpieces within the substantially cylindrically shaped interior chamber; and
a plurality of thermal isolation walls, wherein adjacent thermal isolation walls define a space effective to accommodate and thermally shield each one of the workpieces to be treated and have a height at least equal to a height of the workpiece.

2. The rotary furnace of claim 1, further comprising an inner annular wall, wherein the rotatable hearth is configured to rotate relative to the inner annular wall.

3. The rotary furnace of claim 2, wherein the inner annular wall comprises a heat reflective surface.

4. The rotary furnace of claim 1, wherein each one of the plurality of thermal isolation walls extends from about the inner annular wall to about the refractory lining.

5. The rotary furnace of claim 1, wherein the plurality of thermal isolation walls are formed of a refractory material.

6. The rotary furnace of claim 1, wherein the workpieces comprise billets.

7. The rotary furnace of claim 1, wherein line of sight of the workpieces disposed in the furnace from the opening is substantially prevented.

8. The rotary furnace of claim 1, wherein line of sight between the workpieces disposed in the furnace is substantially prevented.

9. The rotary furnace of claim 1, further comprising one or more heating elements circumferentially disposed about cylindrically shaped interior chamber.

10. The rotary furnace of claim 9, wherein the one or more heating elements are configured for resistive heating.

11. The rotary furnace of claim 9, wherein the one or more heating elements are configured for inductive heating.

12. The rotary furnace of claim 9, wherein the one or more heating elements are configured to provide different heating profiles about a circumference and inner annular wall of the cylindrically shaped interior chamber.

13. The rotary furnace of claim 1, wherein the thermal isolation wall is formed of a graphite material.

14. The rotary furnace of claim 1, wherein the thermal isolation wall is formed of an insulation material.

15. A process for heat treating multiple workpieces in a rotary furnace, comprising:
introducing a first workpiece onto a rotating hearth of the rotary furnace, wherein the rotating hearth comprises a plurality of thermal isolation walls spaced apart from one another, wherein adjacent thermal isolation walls define a space effective to accommodate and thermally shield the first workpiece and have a height at least equal to a height of the first workpiece, and wherein the first workpiece is contained between the adjacent thermal isolation walls;
introducing an additional workpiece onto the rotating hearth, wherein the additional workpiece is disposed between adjacent thermal isolation walls, wherein at least one of the adjacent thermal isolation walls containing the additional workpiece is different than the adjacent thermal isolation walls containing the first workpiece, wherein heat transfer between the first workpiece and the additional workpiece and/or an adjacent heating zone is substantially prevented; and
heat treating the first and additional workpieces.

16. The process of claim 15, wherein the rotary furnace comprises a external shell wall, a refractory lining abutting the external shell wall and an inner annular wall, wherein each one of the plurality of thermal isolation walls extends from about the refractory lining to about the inner annular wall.

17. The process of claim 15, wherein the first and additional workpieces comprise billets.

18. The process of claim 15, wherein line of sight between workpieces disposed in the furnace is substantially prevented.

19. The process of claim 15, further comprising one or more heating elements circumferentially disposed about the cylindrically shaped interior chamber and about the inner annular wall.

20. The process of claim 15, wherein the one or more heating elements are configured to provide different heating profiles about a circumference of the cylindrically shaped interior chamber and the inner annular wall.

21. The process of claim 15, wherein each one of the plurality of thermal isolation walls are formed of a graphite material.

22. The process of claim 15, further comprising operating the rotary furnace at a vacuum in a range of about 0.001 to 10 microns during the heat treating of the first and additional workpieces.
